(19) United States
(12) Patent Application Publication
(10) Pub. No.: US 2025/0246950 A1
(43) Pub. Date: Jul. 31, 2025

(54) DOUBLY SALIENT PARALLEL PATH MAGNETIC MOTOR

(71) Applicant: The University of North Carolina at Charlotte, Charlotte, NC (US)

(72) Inventors: Madhav MANJREKAR, Charlotte, NC (US); Maryam SALEHI, Charlotte, NC (US)

(21) Appl. No.: 18/971,191

(22) Filed: Dec. 6, 2024

Related U.S. Application Data
(60) Provisional application No. 63/626,121, filed on Jan. 29, 2024.

(51) Int. Cl. H02K 1/16

(52) U.S. Cl. CPC H02K 1/165; H02K 2213/03

(57) ABSTRACT

An electric machine assembly including: a rotor; and a stator disposed concentrically about the rotor and separated from the rotor by a gap; where the rotor includes five rotor protrusions disposed concentrically about the rotor; where the stator includes two permanent magnets or direct current coils disposed concentrically about the stator and magnetized is opposing directions, where each of the permanent magnets or direct current coils provides an associated baseline magnetic flux that is adapted to interact with the rotor protrusions; and where the stator includes six stator poles disposed concentrically about the stator, where each of the stator poles is adapted to receive a current to provide an associated induced magnetic flux that is adapted to interact with the rotor protrusions. The stator is divided into two stator segments, where each stator segment includes three stator poles of the six stator poles, and where the two stator segments are separated by the two permanent magnets or direct current coils.

### CROSS-REFERENCE TO RELATED APPLICATION

The present disclosure claims the benefit of priority of co-pending U.S. Provisional Patent Application No. 63/626,121, filed on Jan. 29, 2024, and entitled “DOUBLY SALIENT PARALLEL PATH MAGNETIC MOTOR,” the contents of which are incorporated in full by reference.

### TECHNICAL FIELD

The present disclosure relates generally to the electric machine and transportation fields. More particularly, the present disclosure relates to a doubly salient parallel path magnetic motor (DSPPMM).

### BACKGROUND

Permanent magnet synchronous motors (PMSMs) typically have magnetic flux sources on both sides of an airgap defined between a rotor and a stator. The interaction between these magnetic flux sources causes rotation of the rotor with respect to the stator and torque production. Typically electric coils are disposed on the stator, while permanent magnets are disposed on the rotor. Such conventional configurations lead to constrained operation, excessive heating, and higher cost.

The doubly salient motor (DSM) occupies an interesting niche in the world of electric machines. The DSM combines elements of both permanent magnet (PM) brushless motors and switched reluctance motors (SRMs). While the concept of salient poles dates back to the early days of electric motors, the modern concept of the DSM emerged in the late 20^{th} century, when engineers sought to combine the high power density and efficiency of PM brushless motors with the fault tolerance and robustness of SRMs.

The development of efficient and high performance brushless motors is a significant challenge in the field of electrical engineering, primarily due to the limitations of existing electric motor designs in achieving optimal torque and power output while maintaining compactness and reliability. Conventional brushless motors, such as PMSMs and SRMs, often face issues related to torque ripple, have complex control requirements, and need precise alignment of magnetic fields to achieve desired performance. These electric motors typically require intricate designs to manage the magnetic flux paths and minimize losses, which can complicate manufacturing and increase costs. Additionally, the uneven magnetic field distribution in conventional designs can lead to reduced performance and inefficiencies at varying operational speeds. Addressing these challenges requires innovative approaches that enhance magnetic flux control reduce torque ripple, and improve overall efficiency without significantly increasing complexity or the cost of a design.

### SUMMARY

The DSPPMM of the present disclosure provides a brushless motor design that utilizes a doubly salient structure including a stator with PMs and a reluctance rotor, providing a unique solution to magnetic flux management. Unlike conventional electric motors, the stator of the DSPPMM is divided into two segments, each equipped with three coils, six poles, and two PMs magnetized in opposite orientations. This facilitates a homopolar and near-sinusoidal flux linkage waveform, which results in a sinusoidal back-electromotive force (back-EMF), enhancing performance and efficiency. The rotor of the DSPPMM, akin to that of a SRM, utilizes five protrusions and operates by aligning the rotor poles with the stator poles through the sequential energizing of the stator coils. This design allows for variable air gap flux density due to the salient pole structure, enabling different torque outputs based on the current waveform shape. The DSPPMM achieves high torque and power output (25 Nm and 45 KW, respectively) at a rated speed of 1000 rpm, while maintaining efficiency through its magnetic path and flux control.

The DSPPMM of the present disclosure provides an electric motor with both sources of magnetic flux on the stator, combined with the geometrical construction of a “reluctance rotor,” enabling the magnetic flux to cross the air gap and produce torque. The DSPPMM does not utilize any magnets on the rotor, making the rotor simple and less expensive to manufacture, and allows it to rotate at higher speeds without mechanical integrity concerns to achieve higher power and power density. As the magnets are on the stator, it is easier to cool them than magnets on the rotor, thus preventing demagnetization due to heating and extending the usable range of operation. It is also possible to replace the PMs on the stator with electric coils, providing a magnet free electric motor with all of the advantages of a PM electric motor, such as power density, efficiency, etc.

Example functionalities enabled by the DSPPMM of the present disclosure include, but are not limited to, zero energy “hill hold” required by adventure vehicles, off-road vehicles, agricultural vehicles, boom trucks, cranes, forklifts, elevators, etc., hub electric motors having an outer rotor with an immovable stator as the axle, an axial flux electric motor having multiple stators for take off and cruise modes for electric aircraft, etc., and a linear motor with simple compartment construction devoid of magnets for electric rail and hyperloop, etc. In general, the DSPPMM of the present disclosure is a high power density (>50 kW/ltr, 4× the state of the art), high efficiency (>95%, 2% more than the state of the art) PMSM suited for automotive, adventure vehicle, air/spacecraft, construction vehicle, agricultural vehicle, and industrial/robotic applications, among others.

In some embodiments, the electric machine assembly of the present disclosure includes: a rotor; and a stator disposed concentrically about the rotor and separated from the rotor by a gap; where the rotor includes five rotor protrusions disposed concentrically about the rotor; where the stator includes two permanent magnets or direct current coils disposed concentrically about the stator and magnetized is opposing directions, where each of the permanent magnets or direct current coils provides an associated baseline magnetic flux that is adapted to interact with the rotor protrusions; and where the stator includes six stator poles disposed concentrically about the stator, where each of the stator poles is adapted to receive a current to provide an associated induced magnetic flux that is adapted to interact with the rotor protrusions. The stator is divided into two stator segments, where each stator segment includes three stator poles of the six stator poles, and where the two stator segments are separated by the two permanent magnets or direct current coils. Each of the stator poles includes a stator tooth disposed concentrically about the stator and an associated stator coil. The baseline magnetic flux and/or the induced magnetic flux are adapted to arrest or cause rotation of the rotor with respect to the stator. In some embodiments, the baseline magnetic flux is adapted to arrest rotation of the rotor with respect to the stator. The current provided to each of the stator poles has a square, near sinusoidal, or sinusoidal current waveform. The stator poles are sequentially energized and de-energized to impart a torque on the rotor. The electric machine assembly is utilized in one of an electric vehicle, industrial machinery, a robot, a turbine generator, etc.

In some embodiments, the electric machine method of the present disclosure includes providing an electric machine assembly including: a rotor; and a stator disposed concentrically about the rotor and separated from the rotor by a gap; where the rotor includes five rotor protrusions disposed concentrically about the rotor, where; where the stator includes two permanent magnets or direct current coils disposed concentrically about the stator and magnetized is opposing directions, where each of the permanent magnets or direct current coils provides an associated baseline magnetic flux that is adapted to interact with the rotor protrusions; and where the stator includes six stator poles disposed concentrically about the stator, where each of the stator poles is adapted to receive a current to provide an associated induced magnetic flux that is adapted to interact with the rotor protrusions; and sequentially energizing and de-energizing the stator poles to impart a torque on the rotor. The stator is divided into two stator segments, where each stator segment includes three stator poles of the six stator poles, and where the two stator segments are separated by the two permanent magnets or direct current coils. Each of the stator poles includes a stator tooth disposed concentrically about the stator and an associated stator coil. The baseline magnetic flux and/or the induced magnetic flux are adapted to arrest or cause rotation of the rotor with respect to the stator. In some embodiments, the baseline magnetic flux is adapted to arrest rotation of the rotor with respect to the stator. The current provided to each of the stator poles has a square, near sinusoidal, or sinusoidal current waveform. The electric machine assembly is utilized in one of an electric vehicle, industrial machinery, a robot, a turbine generator, etc.

It will be readily apparent to those of ordinary skill in the art that features and aspects of the above embodiments may be included, omitted, and/or combined as desired in a given application, without limitation.

### BRIEF DESCRIPTION OF THE DRAWINGS

The present disclosure is illustrated and described with reference to the various drawings, in which like reference numbers are used to denote like assembly components/method steps, as appropriate, and in which:

FIG. 1 is a cross-sectional view of one embodiment of the DSPPMM of the present disclosure;

FIG. 2 is a series of open circuit field distributions for the DSPPMM of FIG. 1;

FIG. 3 is a series of flux linkages and back-EMFs for the DSPPMM of FIG. 1;

FIG. 4 is a series of flux linkages, back-EMFs, and current excitations for the DSPPMM of FIG. 1;

FIG. 5 is a series of schematic diagrams illustrating the operation of the DSPPMM of the present disclosure, with the rotor and stator at six cardinal positions;

FIG. 6 is a series of field distributions at six positions for the DSPPMM of FIG. 1, with clockwise rotation; and

FIG. 7 is a series of current excitations and torque versus peak current profiles for the DSPPMM of FIG. 1.

It will be readily apparent to those of ordinary skill in the art that features and aspects of the above embodiments may be included, omitted, and/or combined as desired in a given application, without limitation.

### DETAILED DESCRIPTION

Again, the DSPPMM of the present disclosure provides a brushless motor design that utilizes a doubly salient stator with PMs, providing a unique solution to magnetic flux management. Unlike conventional electric motors, the stator of the DSPPMM is divided into two segments, each equipped with three coils, six poles, and two PMs magnetized in opposite orientations. This facilitates a homopolar and near sinusoidal flux linkage waveform, which results in a sinusoidal back-electromotive force (back-EMF), enhancing performance and efficiency. The rotor of the DSPPMM, akin to that of a SRM, utilizes five protrusions and operates by aligning the rotor poles with the stator poles through the sequential energizing of the stator coils. This design allows for variable air gap flux density due to the salient pole structure, enabling different torque outputs based on the current waveform shape. The DSPPMM achieves high torque and power output (25 Nm and 45 kW, respectively) at a rated speed of 1000 rpm, while maintaining efficiency through its magnetic path and flux control.

The DSPPMM of the present disclosure provides an electric motor with both sources of magnetic flux on the stator, combined with the geometrical construction of a “reluctance rotor,” enabling the magnetic flux to cross the air gap and produce torque. The DSPPMM does not utilize any magnets on the rotor, making the rotor simple and less expensive to manufacture, and allow it to rotate at higher speeds without mechanical integrity concerns to achieve higher power and power density. As the magnets are on the stator, it is easier to cool them than magnets on the rotor, thus preventing demagnetization due to heating and extending the usable range of operation. It is also possible to replace the PMs on the stator with electric coils, providing a magnet free electric motor with all of the advantages of a PM electric motor, such as power density, efficiency, etc.

Example functionalities enabled by the DSPPMM of the present disclosure include, but are not limited to, zero energy “hill hold” required by adventure vehicles, boom trucks, cranes, forklifts, elevators, etc., hub electric motors having an outer rotor with an immovable stator as the axle, an axial flux electric motor having multiple stators for take off and cruise modes for electric aircraft, etc., and a linear motor with simple compartment construction devoid of magnets for electric rail and hyperloop, etc. In general, the DSPPMM of the present disclosure is a high power density (>50 kW/ltr, 4× the state of the art), high efficiency (>95%, 2% more than the state of the art) PMSM suited for automotive, adventure vehicle, air/spacecraft, construction vehicle, agricultural vehicle, and industrial/robotic applications, among others.

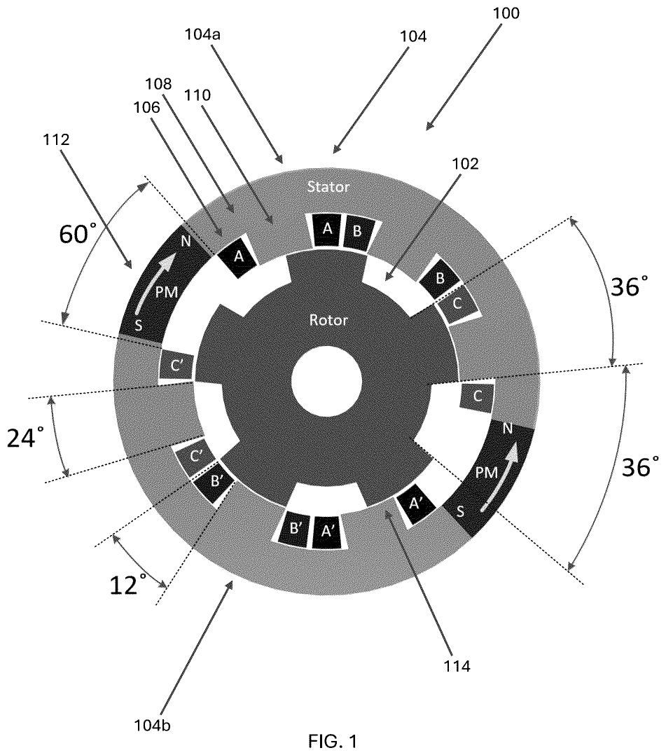

Referring to FIG. 1, the DSPPMM 100 includes a concentrically disposed rotor 102 and stator 104, with the stationary stator 104 disposed about the rotating rotor 102 in the embodiment illustrated. The stator 104 is divided into two segments 104a, 104b, each segment 104a, 104b utilizing three stator coils 106 to control the magnetic flux path direction, six stator poles 108 and six stator teeth 110, and two stator PMs 112 that are magnetized in opposing directions. For the first stator segment 104a, the stator coils 106 are phases A, B, and C. For the second stator segment 104b, the stator coils 106 are phases A′, B′, and C′. The rotor 102 is that of a SRM, utilizing five rotor protrusions 114. The stator coils 106 are activated to provide an induced magnetic flux, while the PMs 112 provide a baseline magnetic flux. These magnetic fluxes are combined to cause torque on the rotor protrusions 114 when the stator coils 106 are activated, with the baseline magnetic flux of the PMs 112 effectively locking the rotor 102 to the stator 104 when the stator coils 106 are not activated. It will be readily apparent to those of ordinary skill in the art that direct current (DC) coils may be substituted for the PMs 112 and serve a similar purpose. It will also be readily apparent to those of ordinary skill in the art that the rotor 102 can be turned inside out in all embodiments, providing an outer rotor or hub motor.

As illustrated, each segment 104a, 104b of the stator 104 occupies 120 degrees, with each stator coil segment occupying roughly 12 degrees (roughly 24 degrees total for each stator coil 106), each stator pole 108 occupying 36-48 degrees, each stator tooth 110 occupying 24 degrees, each stator PM occupying 60 degrees, each rotor protrusion 114 occupying 36 degrees, and the rotor protrusions separated by 36 degrees.

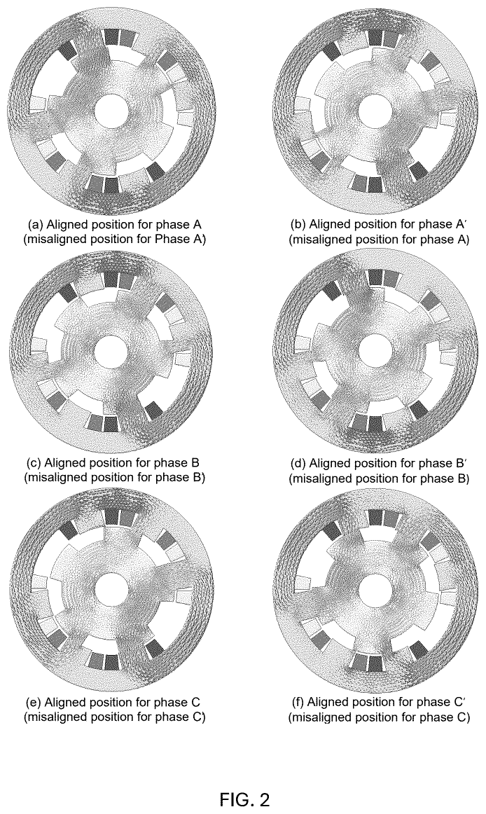

Referring to FIG. 2, for phase A, when the rotor protrusion 114 aligns with the stator tooth 110, the magnetic flux linkage reaches its maximum (case (a)), while when the rotor protrusion 114 does not align with the stator tooth 110, the magnetic flux linkage is zero (case (b)). Likewise, for phase B, when the rotor protrusion 114 aligns with the stator tooth 110, the magnetic flux linkage reaches its maximum (case (c)), while when the rotor protrusion 114 does not align with the stator tooth 110, the magnetic flux linkage is zero (case (d)). Likewise, for phase C, when the rotor protrusion 114 aligns with the stator tooth 110, the magnetic flux linkage reaches its maximum (case (e)), while when the rotor protrusion 114 does not align with the stator tooth 110, the magnetic flux linkage is zero (case (f)).

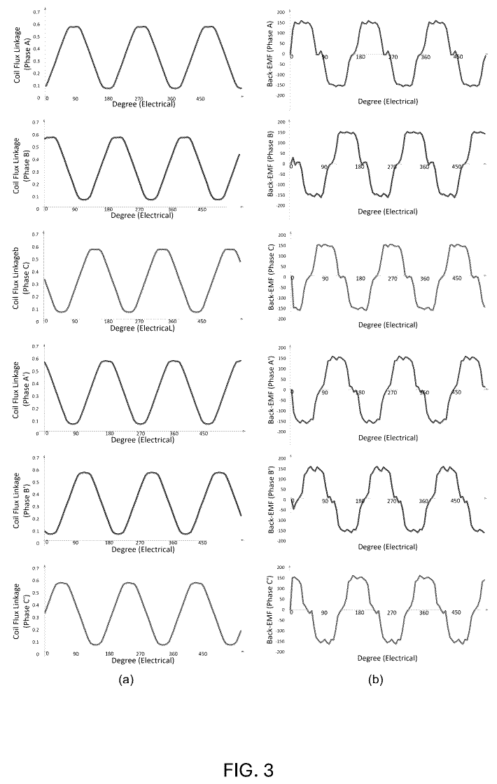

Referring to FIG. 3, the per phase magnetic flux linkage waveform of the DSPPMM 100 is homopolar and near sinusoidal (a), which results in a near sinusoidal back-EMF (b), even when concentrated stator windings are employed.

Table 1 provides sample specification and electric machine parameters employed to model the DSPPMM 100.

TABLE 1

| Quantity | Value | Quantity | Value |
|---|---|---|---|
| Rated speed (rpm) | 1000 | Maximum Speed (rpm) | 10000 |
| Peak power (kW) | 45 | Peak torque (Nm) | 250 |
| Stator OD (mm) | 180 | Stator stack length (mm) | 180 |
| Current density (A/mm²) | 8 | Magnet thickness (mm) | 55 |
| Air gap length (mm) | 1 | Number of turns per | 70 |
| | | coil phase | |

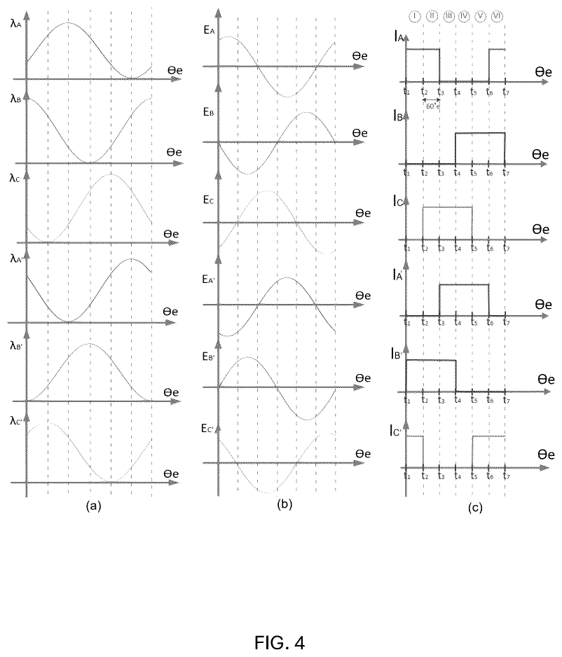

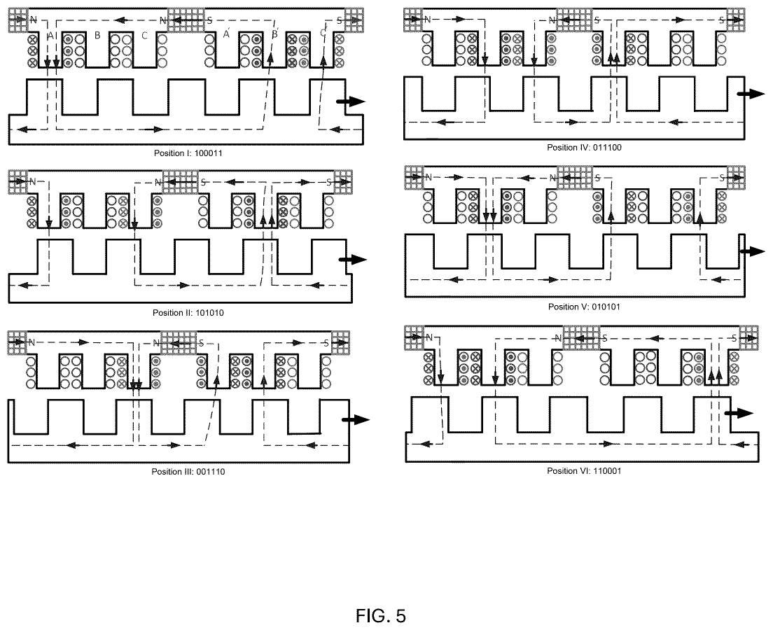

Referring to FIGS. 4 and 5, the stator coils 106 are energized to align the rotor protrusions 114 with the stator poles 108. The current sequence is designed to facilitate alignment of the rotor protrusions 114 with the stator poles 108. FIG. 4 illustrates the ideal flux linkage (a) and back-EMF (b), taken from the corresponding waveforms of the DSPPMM 100 of FIG. 3. The six stator windings 106 are energized, as shown in (c), to synchronize with the back-EMF (b). As observed, each phase is electrically shifted by 60 degrees.

There are six cardinal regions, named I, II, III, IV, V, and VI as shown in (c) and illustrated in FIG. 5.

At time t₁, stator coils A and C′ are energized, while stator coil B is de-energizing, and stator coil B′ is starting to energize (Position I). This configuration imparts rotational torque to the rotor 102, causing it to rotate clockwise. In FIG. 5, Position I (100011), shows the magnetic flux lines of PM₁ and PM₂ when stator coils A, B′, and C′ are powered, and the others are turned off.

To make the clockwise rotation in the rotor 102, at time t₂, stator coil C′ is de-energized, and stator coil C is turning on. In FIG. 5 Position II (101010), the direction of the magnetic flux paths is depicted when coils A, C, and B′ are energized.

At time t₃, stator coil A is de-energizing, and stator coil A′ is starting to energize. The flux lines regulated by stator coils C, A′, and B′ are displayed in FIG. 5, Position III.

By rotating the rotor 102 12 degrees mechanically (60 degrees electrically), stator coil B′ is turning off and, instead, stator coil B is turning on (at time t₄). Through the stator teeth 108 encircled by stator coils B, C, and A′, Position IV, the magnetic flux lines close their path.

In the next step, stator coils B and A′ remain on, while stator coil C flips off to activate stator coil C′ (at time t₅). The flux lines' path, being governed by stator coils B, A′, and C′, is displayed in Position V.

Switching off stator coil A and turning on stator coil A′ at time to is the next stage. The flux lines, which are controlled by phase A, B, and C′, are displayed at Position VI.

Thus, a stator coil 106 is de-energized in each sequence (every 60 degrees of electrical interval) to allow for the activation of its corresponding coil. For instance, switching off stator coil A results in the activation of stator coil A′.

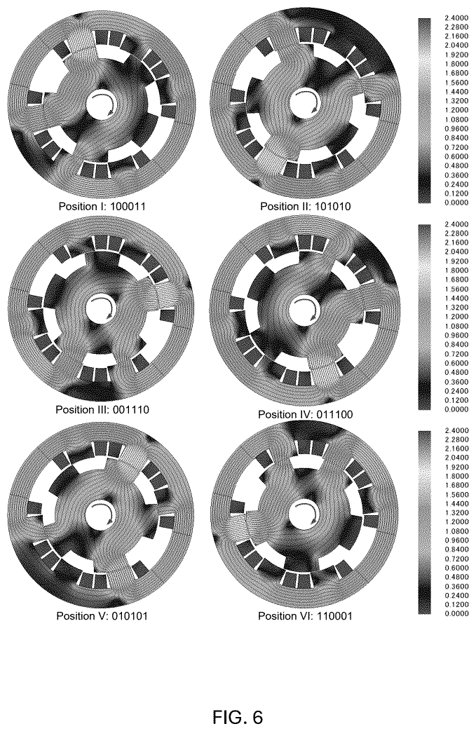

For the DSPPMM 100, air gap flux density is not constant and varies as the rotor 102 rotates. This is because the salient poles on the rotor 102 and the stator 104 create an uneven magnetic field distribution, giving rise to a varying air gap flux density. FIG. 6 shows the field distribution of the DSPPMM at the six cardinal positions.

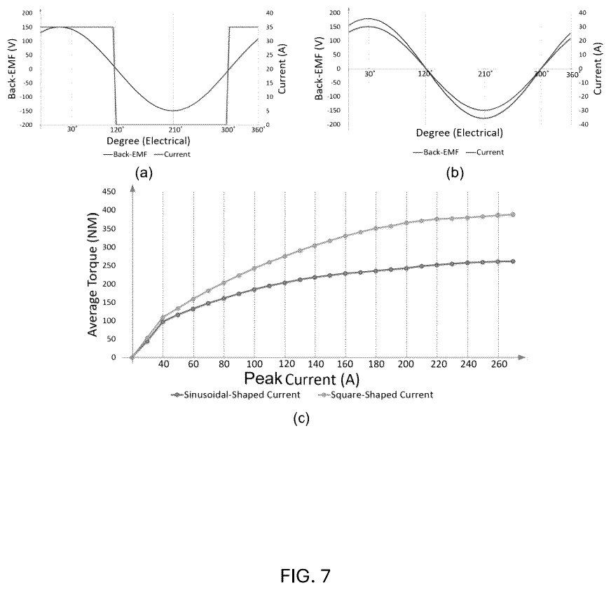

When the DSPPMM 100 was subjected to square and sinusoidal-shaped currents in synchronism with the back-EMF, the generated torque was 109 Nm and 97 Nm, respectively. FIG. 7 show the current excitation for phase A of the motor for square-shaped (a) and sinusoidal-shaped (b) inputs, which are in phase with the back-EMF of the DSPPMM. The torque versus current profiles under square-shaped and sinusoidal-shaped excitation conditions are shown in (c).

Thus, the present disclosure provides an electric machine that produces torque and enables motion using a combination of electromagnets and PMs in the stationary component (i.e., stator of the motor). The moving component (i.e., rotor of the motor) utilizes a ferromagnetic material with protrusions. A three-phase power electronic drive with a controller is used to regulate currents for high torque, high speed, and high efficiency modes of operation in automotive and industrial applications.

The high torque density and efficiency of the DSPPMM make it ideal for use in electric vehicle (EV) drive systems. Its near sinusoidal back-EMF and ability to operate with various current waveforms allow for smooth and efficient power delivery, improving vehicle performance and range as compared to existing EV motors. Likewise, the high torque output and compact design of the DSPPMM are well suited for direct drive applications in robotics and automation. Its precise controllability and near sinusoidal back-EMF enable smooth and accurate motion control, eliminating the need for gears and reducing complexity in robotic arms and actuators. Likewise, the ability of the DSPPMM to generate a near sinusoidal back-EMF with minimal cogging torque makes it suitable for wind turbine generators. Its high efficiency across a wide operating range optimizes energy capture from varying wind speeds, leading to increased energy production as compared to conventional generators.

Although the present disclosure is illustrated and described with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. An electric machine assembly comprising:
a rotor; and
a stator disposed concentrically about the rotor and separated from the rotor by a gap;
wherein the rotor comprises five rotor protrusions disposed concentrically about the rotor;
wherein the stator comprises two permanent magnets or direct current coils disposed concentrically about the stator and magnetized is opposing directions, wherein each of the permanent magnets or direct current coils provides an associated baseline magnetic flux that is adapted to interact with the rotor protrusions; and
wherein the stator comprises six stator poles disposed concentrically about the stator, wherein each of the stator poles is adapted to receive a current to provide an associated induced magnetic flux that is adapted to interact with the rotor protrusions.

2. The electric machine assembly of claim 1, wherein the stator is divided into two stator segments, wherein each stator segment comprises three stator poles of the six stator poles, and wherein the two stator segments are separated by the two permanent magnets or direct current coils.

3. The electric machine assembly of claim 1, wherein each of the stator poles comprises a stator tooth disposed concentrically about the stator and an associated stator coil.

4. The electric machine assembly of claim 1, wherein the baseline magnetic flux and/or the induced magnetic flux are adapted to arrest or cause rotation of the rotor with respect to the stator.

5. The electric machine assembly of claim 1, wherein the baseline magnetic flux is adapted to arrest rotation of the rotor with respect to the stator.

6. The electric machine assembly of claim 1, wherein the current provided to each of the stator poles has a square, near sinusoidal, or sinusoidal current waveform.

7. The electric machine assembly of claim 1, wherein the stator poles are sequentially energized and de-energized to impart a torque on the rotor.

8. The electric machine assembly of claim 1, wherein the rotor and the stator are manufactured from a ferromagnetic material.

9. The electric machine assembly of claim 1, wherein the electric machine assembly is utilized in one of an electric vehicle, industrial machinery, a robot, and a turbine generator.

10. An electric machine method comprising:
providing an electric machine assembly comprising:
a rotor; and
a stator disposed concentrically about the rotor and separated from the rotor by a gap;
wherein the rotor comprises five rotor protrusions disposed concentrically about the rotor;
wherein the stator comprises two permanent magnets or direct current coils disposed concentrically about the stator and magnetized is opposing directions, wherein each of the permanent magnets or direct current coils provides an associated baseline magnetic flux that is adapted to interact with the rotor protrusions; and
wherein the stator comprises six stator poles disposed concentrically about the stator, wherein each of the stator poles is adapted to receive a current to provide an associated induced magnetic flux that is adapted to interact with the rotor protrusions; and
sequentially energizing and de-energizing the stator poles to impart a torque on the rotor.

11. The electric machine method of claim 10, wherein the stator is divided into two stator segments, wherein each stator segment comprises three stator poles of the six stator poles, and wherein the two stator segments are separated by the two permanent magnets or direct current coils.

12. The electric machine method of claim 10, wherein each of the stator poles comprises a stator tooth disposed concentrically about the stator and an associated stator coil.

13. The electric machine method of claim 10, wherein the baseline magnetic flux and/or the induced magnetic flux are adapted to arrest or cause rotation of the rotor with respect to the stator.

14. The electric machine method of claim 10, wherein the baseline magnetic flux is adapted to arrest rotation of the rotor with respect to the stator.

15. The electric machine method of claim 10, wherein the current provided to each of the stator poles has a square, near sinusoidal, or sinusoidal current waveform.

16. The electric machine assembly of claim 1, wherein the rotor and the stator are manufactured from a ferromagnetic material.

17. The electric machine method of claim 10, wherein the electric machine assembly is utilized in one of an electric vehicle, industrial machinery, a robot, and a turbine generator.

18. An electric motor assembly for a electric vehicle, the electric motor comprising:
a rotor adapted to be coupled to a drive wheel of the electric vehicle; and
a stator disposed concentrically about the rotor and separated from the rotor by a gap;
wherein the rotor comprises five rotor protrusions disposed concentrically about the rotor;
wherein the stator comprises two permanent magnets or direct current coils disposed concentrically about the stator and magnetized is opposing directions, wherein each of the permanent magnets or direct current coils provides an associated baseline magnetic flux that is adapted to interact with the rotor protrusions; and
wherein the stator comprises six stator poles disposed concentrically about the stator, wherein each of the stator poles is adapted to receive a current to provide an associated induced magnetic flux that is adapted to interact with the rotor protrusions.

19. The electric motor assembly of claim 18, wherein the stator is divided into two stator segments, wherein each stator segment comprises three stator poles of the six stator poles, and wherein the two stator segments are separated by the two permanent magnets or direct current coils.

20. The electric motor assembly of claim 18, wherein each of the stator poles comprises a stator tooth disposed concentrically about the stator and an associated stator coil.
